(19) United States
(12) Patent Application Publication
(10) Pub. No.: US 2015/0255000 A1
(43) Pub. Date: Sep. 10, 2015

(54) SYSTEMS AND METHODS FOR TARGETING SPECIFIC BENEFITS WITH COGNITIVE TRAINING

(71) Applicant: LUMOS LABS, INC., San Francisco, CA (US)

(72) Inventors: Joseph L. HARDY, El Cerrito, CA (US); Tieming JI, Ames, IA (US); Michael D. SCANLON, San Francisco, CA (US)

(21) Appl. No.: 14/720,161

(22) Filed: May 22, 2015

Related U.S. Application Data
(63) Continuation of application No. 13/622,446, filed on Sep. 19, 2012, now abandoned.
(60) Provisional application No. 61/536,939, filed on Sep. 20, 2011.

(51) Int. Cl. G09B 19/00; G09B 7/00; G09B 5/06

(52) U.S. Cl. CPC G09B 19/00; G09B 5/06; G09B 7/00

(57) ABSTRACT

The disclosure is directed to methods for enhancing cognition in a participant by dynamically constructing a cognitive training regime to exercise desired benefits. Additionally, computer implemented methods for enhancing cognition in a participant by dynamically constructing a cognitive training regime to exercise desired benefits are also provided. The methods and systems disclosed include the use or implementation of computer comprising: a processor; and a memory coupled to the processor, the memory comprising computer-executable instructions that when executed by the processor perform operations including: dynamically constructing a cognitive training regime to exercise desired benefits.

### CROSS-REFERENCE

This application is a continuation application of U.S. patent application Ser. No. 13/622,446 filed Sep. 19, 2012, which claims the benefit of Provisional Application No. 61/536,939, filed Sep. 20, 2011, which applications are incorporated herein by reference.

### BACKGROUND OF THE INVENTION

Cognitive training is an effective way of enhancing mental abilities in humans. Dozens of articles have been written in peer-reviewed journals describing the benefits of cognitive training. Benefits of cognitive training include improving many real-world abilities, such as driving, performing well in school, and carrying out other activities of daily living.

Up to now systems and methods have not existed by which one, e.g. a health care practitioner or an individual user, could dynamically construct a cognitive training regimen to optimally exercise the brain to achieve specific desired benefits. Thus, systems and methods for targeting specific benefits with cognitive training are needed.

### SUMMARY OF THE INVENTION

Systems and methods for targeting cognitive training for specific, user-identified, desired real world benefits takes advantage of the presence of shared variance in performance on cognitive and real-world tasks and abilities. The user-identified real world benefits can be selected by an individual user or by, for example a third person such as a health care practitioner working with a patient assisting the patient in improving cognitive abilities. This shared variance is caused by mutual dependence on underlying neural mechanisms. This shared variance is represented in a multidimensional cognitive space that is the basis of the method. The systems and methods are configurable for targeting cognitive training for users of all ages.

Individual performance across various tasks that depend upon cognitive performance abilities (e.g., memory, attention, reasoning, etc.) is correlated to varying degrees. The degree of correlation depends on how much performance of the various tasks is limited by the efficiency of shared, underlying neurocognitive mechanisms. For example, performance on two tasks—such as digit span and visual memory span—that depend to a large degree on working memory capacity will tend to be highly correlated. This system of correlation between cognitive tasks, as mediated by underlying cognitive abilities, can be described mathematically using dimensionality reduction techniques such as factor analysis (FA) and principle components analysis (PCA). In the present systems and methods, individual users perform a variety of cognitive tasks, such as the exercises and assessments using the system, and answer questions about themselves, such as these: (1) How many motor vehicle accidents have you been in over the past three (3) years?; (2) What was your grade point average (GPA) in your most recent year of schooling?; and (3) What was your score on the Scholastic Aptitude Test (SAT)? The cognitive space can be defined on the population, across users, based on data in a database.

The exercises are based on the principals of neuroplasticity. These activities target different neurocognitive domains, including attention, working memory, speed of processing, cognitive flexibility, and problem solving. The exercises are designed to enhance cognitive ability at the level of underlying neurocognitive mechanisms, and are intensive and adaptively challenging. The assessments are designed to test performance related to underlying cognitive abilities.

The exercises, assessments and questions can be implemented on a remote computing system such a website or mobile application (e.g., smart phone or tablet). The data about cognitive task performance (exercises and assessments) and real-world cognitive activities (questions) are storable within a database. Performance on each measurement variable is standardizable (e.g., z-score normalization, where mean is 0 and standard deviation is ±1) such that better performance on a particular selected task (e.g., fewer accidents, more items recalled, less time to react to a stimulus, etc.) is represented as a higher number. Demographic data such as age, education and sex are recordable and storable in a database as well.

An aspect of the disclosure is directed to a non-transitory computer readable medium storing instructions that, when executed by a computing device, causes the computing device to perform a method comprising: receiving from a user computing device at least one of an identifier for a desired benefit and an identifier for a current skill; identifying, for the at least one of the identifier for the desired benefit and the identifier for the current skill, a coordinate position wherein the coordinate position is further comprised of two or more of a real-world task component, a cognitive exercise component, and a cognitive ability dimension component; determining a cluster position from at least two or more of the identified real-world task component, cognitive exercise component, and cognitive ability dimension for the at least one of the identifier for the desired benefit and the identifier for the current skill; and selecting one or more visual stimuli for training and audible stimuli for training for presentation to the user based on the calculated probability. In some aspects, the method is configurable to provide the step of calculating a probability, for one or more visual stimuli for training and audible stimuli for training, that the training will be presented to the user as a function the cluster position of the at least one of the identifier for the desired benefit and the identifier for the current skill. In this step, for example, the receiving takes place via a web-server. Additionally, providing the at least one of the visual stimuli for training (such as graphics and video) and the audible stimuli for training to the user computing device can be accomplished via a web-server to the user computing device. Additional steps include, for example, one or more of each of providing the user computing device the selected one of a visual stimuli for training and an audible stimuli for training for enhancing cognition in the user, requiring the participant to respond to the stimuli, analyzing the participant response, assigning a difficulty rating of the one or more visual stimuli for training and audible stimuli for training. Additionally, the probability is calculatable according to an equation

$${p}_{ai} = \frac{{d}_{ai}}{{\sum }_{j = 1}^{J} {d}_{aj}}$$

where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a. In at least some configurations, the step of ordering the one or more visual stimuli for training and audible stimuli for training, and presenting the one or more visual stimuli for training and audible stimuli for training in can be performed such that an order based on the difficulty rating.

Another aspect of the disclosure is directed to a computing device comprising: a processor configured to: receive from a user computing device at least one of an identifier for a desired benefit and an identifier for a current skill; identify, for the at least one of the identifier for the desired benefit and the identifier for the current skill, a coordinate position wherein the coordinate position is further comprised of two or more of a real-world task component, a cognitive exercise component, and a cognitive ability dimension component; calculate a cluster position from at least two or more of the identified real-world task component, cognitive exercise component, and cognitive ability dimension for the at least one of the identifier for the desired benefit and the identifier for the current skill; and select one or more visual stimuli for training and audible stimuli for training for presentation to the user based on the calculated probability. In some aspects, the processor is configurable to enable the step of calculating a probability, for one or more visual stimuli for training and audible stimuli for training, that the training will be presented to the user as a function the cluster position of the at least one of the identifier for the desired benefit and the identifier for the current skill. In some configurations, for example, the receiving takes place via a web-server. Additionally, providing the at least one of the visual stimuli for training (such as graphics and video) and the audible stimuli for training to the user computing device can be accomplished via a web-server to the user computing device. In other configurations, the processor is configurable to achieve additional steps, for example, one or more of each of providing the user computing device the selected one of a visual stimuli for training and an audible stimuli for training for enhancing cognition in the user, requiring the participant to respond to the stimuli, analyzing the participant response, assigning a difficulty rating of the one or more visual stimuli for training and audible stimuli for training. Additionally, the probability is calculatable according to an equation

$${p}_{ai} = \frac{{d}_{ai}}{{\sum }_{j = 1}^{J} {d}_{aj}}$$

where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a. In at least some configurations, one or more visual stimuli for training and audible stimuli for training, and presenting the one or more visual stimuli for training and audible stimuli for training can be ordered, and presented based on, for example, a difficulty rating.

Yet another aspect of the disclosure is directed to a system comprising: a web-server configured to: receive from a user computing device at least one of an identifier for a desired benefit and an identifier for a current skill; identify, for the at least one of the identifier for the desired benefit and the identifier for the current skill, a coordinate position wherein the coordinate position is further comprised of two or more of a real-world task component, a cognitive exercise component, and a cognitive ability dimension component; calculate a cluster position from at least two or more of the identified real-world task component, cognitive exercise component, and cognitive ability dimension for the at least one of the identifier for the desired benefit and the identifier for the current skill; and select one or more visual stimuli for training and audible stimuli for training for presentation to the user based on the calculated probability. In some aspects, the system is configurable to provide the step of calculating a probability, for one or more visual stimuli for training and audible stimuli for training, that the training will be presented to the user as a function the cluster position of the at least one of the identifier for the desired benefit and the identifier for the current skill. In this step, for example, the receiving takes place via a web-server. Additionally, providing the at least one of the visual stimuli for training (such as graphics and video) and the audible stimuli for training to the user computing device can be accomplished via a web-server to the user computing device. Additional steps include, for example, one or more of each of providing the user computing device the selected one of a visual stimuli for training and an audible stimuli for training for enhancing cognition in the user, requiring the participant to respond to the stimuli, analyzing the participant response, assigning a difficulty rating of the one or more visual stimuli for training and audible stimuli for training. Additionally, the probability is calculatable according to an equation

$${p}_{ai} = \frac{{d}_{ai}}{{\sum }_{j = 1}^{J} {d}_{aj}}$$

where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a. In at least some configurations, the step of ordering the one or more visual stimuli for training and audible stimuli for training, and presenting the one or more visual stimuli for training and audible stimuli for training in can be performed such that an order based on the difficulty rating.

Still another aspect of the disclosure is directed to a method comprising: receiving from a user computing device at least one of an identifier for a desired benefit and an identifier for a current skill; identifying, for the at least one of the identifier for the desired benefit and the identifier for the current skill, a coordinate position wherein the coordinate position is further comprised of two or more of a real-world task component, a cognitive exercise component, and a cognitive ability dimension component; calculating a cluster position from at least two or more of the identified real-world task component, cognitive exercise component, and cognitive ability dimension for the at least one of the identifier for the desired benefit and the identifier for the current skill; and selecting one or more visual stimuli for training and audible stimuli for training for presentation to the user based on the calculated probability. In some aspects, the method is configurable to provide the step of calculating a probability, for one or more visual stimuli for training and audible stimuli for training, that the training will be presented to the user as a function the cluster position of the at least one of the identifier for the desired benefit and the identifier for the current skill. In this step, for example, the receiving takes place via a web-server. Additionally, providing the at least one of the visual stimuli for training (such as graphics and video) and the audible stimuli for training to the user computing device can be accomplished via a web-server to the user computing device. Additional steps include, for example, one or more of each of providing the user computing device the selected one of a visual stimuli for training and an audible stimuli for training for enhancing cognition in the user, requiring the participant to respond to the stimuli, analyzing the participant response, assigning a difficulty rating of the one or more visual stimuli for training and audible stimuli for training. Additionally, the probability is calculatable according to an equation

$${p}_{ai} = \frac{{d}_{ai}}{{\sum }_{j = 1}^{J} {d}_{aj}}$$

where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a. In at least some configurations, the step of ordering the one or more visual stimuli for training and audible stimuli for training, and presenting the one or more visual stimuli for training and audible stimuli for training in can be performed such that an order based on the difficulty rating.

Yet another aspect of the disclosure is directed to a method comprising: transmitting, via a user computing device a user request to a web-server over a network; receiving from a user computing device at least one of an identifier for a desired benefit and an identifier for a current skill; identifying, for the at least one of the identifier for the desired benefit and the identifier for the current skill, a coordinate position wherein the coordinate position is further comprised of two or more of a real-world task component, a cognitive exercise component, and a cognitive ability dimension component; calculating a cluster position from the identified two or more of real-world task component, cognitive exercise component, and cognitive ability dimension for the at least one of the identifier for the desired benefit and the identifier for the current skill; and selecting one or more visual stimuli for training and audible stimuli for training for presentation to the user based on the calculated probability. In some aspects, the method is configurable to provide the step of calculating a probability, for one or more visual stimuli for training and audible stimuli for training, that the training will be presented to the user as a function the cluster position of the at least one of the identifier for the desired benefit and the identifier for the current skill. In this step, for example, the receiving takes place via a web-server. Additionally, providing the at least one of the visual stimuli for training (such as graphics and video) and the audible stimuli for training to the user computing device can be accomplished via a web-server to the user computing device. Additional steps include, for example, one or more of each of providing the user computing device the selected one of a visual stimuli for training and an audible stimuli for training for enhancing cognition in the user, requiring the participant to respond to the stimuli, analyzing the participant response, assigning a difficulty rating of the one or more visual stimuli for training and audible stimuli for training. Additionally, the probability is calculatable according to an equation

$${p}_{ai} = \frac{{d}_{ai}}{{\sum }_{j = 1}^{J} {d}_{aj}}$$

where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a. In at least some configurations, the step of ordering the one or more visual stimuli for training and audible stimuli for training, and presenting the one or more visual stimuli for training and audible stimuli for training in can be performed such that an order based on the difficulty rating.

### INCORPORATION BY REFERENCE

All publications, patents, and patent applications mentioned in this specification are herein incorporated by reference to the same extent as if each individual publication, patent, or patent application was specifically and individually indicated to be incorporated by reference. Patents and publications of interest to the field include, for example, U.S. Pat. No. 7,773,097 B2 issued Aug. 10, 2010, to Merzenich for Visual Emphasis for Cognitive Training Exercises; and U.S. Pat. No. 7,540,615 B2 issued Jun. 2, 2009 to Merzenich for Cognitive Training Using Guided Eye Movements.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A is a diagram showing a representative example of a logic device through which targeting specific benefits with cognitive training can be achieved;

FIG. 1B is a block diagram of an exemplary computing environment through which targeting specific benefits with cognitive training can be achieved;

FIG. 1C is an illustrative architectural diagram showing some structure that can be employed by devices through which targeting specific benefits with cognitive training is achieved;

FIG. 2 is a diagram showing the cooperation of exemplary components of a system suitable for use in a system where targeting specific benefits with cognitive training is achieved;

FIG. 3 illustrates the principal components of the cognitive structure;

FIG. 4 is a chart that shows a representation of a subset of the coordinate position emerging from tasks;

FIG. 5 illustrates a screenshot showing a basic stimulus display for an exercise;

FIG. 6 is a screenshot of an exercise where the user is required to remember the location of three (3) sets of coins;

FIG. 7 is a screenshot of an exercise where a user completes three letter word stems; and

FIG. 8 is a cluster dendrogram illustrating a relationship between exercises of the system.

### DETAILED DESCRIPTION OF THE INVENTION

### I. Computing Systems

The systems and methods described herein rely on a variety of computer systems, networks and/or digital devices for operation. In order to fully appreciate how the system operates an understanding of suitable computing systems is useful. The systems and methods disclosed herein are enabled as a result of application via a suitable computing system.

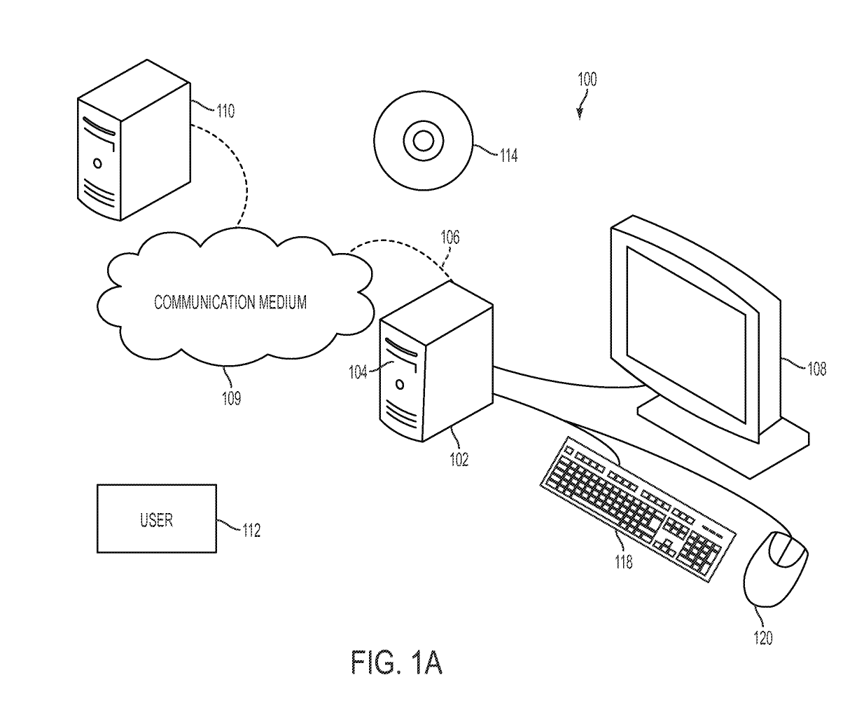

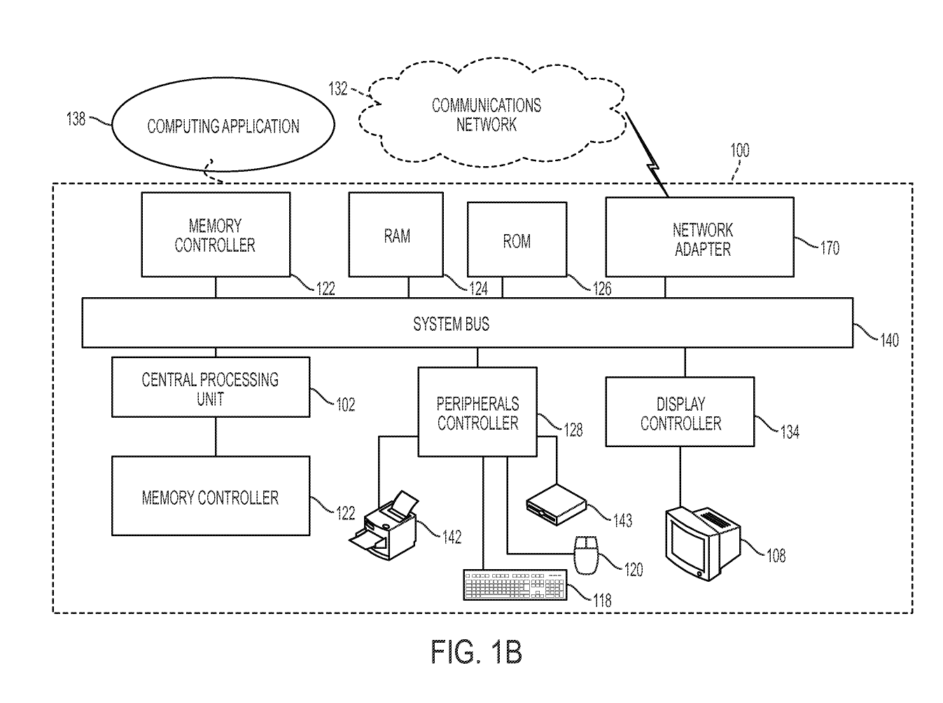

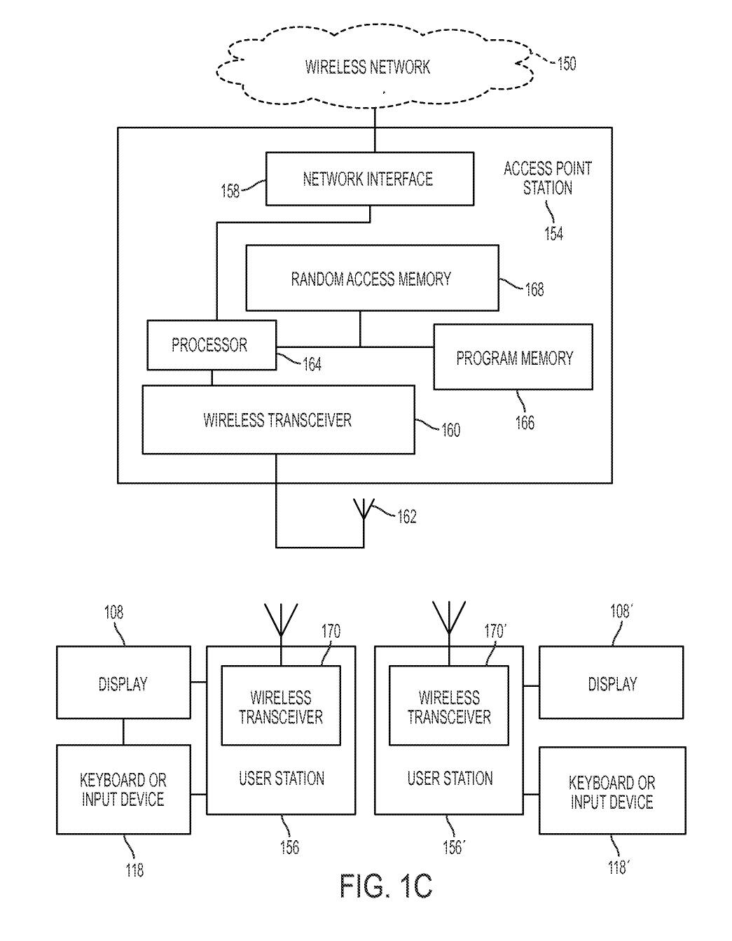

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and has a fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present disclosure can be transmitted over such networks or connections. The computer system can be adapted to communicate with a participant and/or a device used by a participant. The computer system is adaptable to communicate with other computers over the Internet, or with computers via a server.

FIG. 1B depicts another exemplary computing system 100. The computing system 100 has computer readable medium that is capable of executing a variety of computing applications 138, including computing applications, a computing applet, a computing program, or other instructions for operating on computing system 100 to perform at least one function, operation, and/or procedure. The computer readable storage media for tangibly storing computer readable instructions, which may be in the form of software. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some embodiments may be implemented in one or a combination of hardware, firmware and software. Embodiments may also be implemented as instructions stored on a non-transitory computer-readable storage medium, which may be read and executed by at least one processor to perform the operations described herein. A non-transitory computer-readable storage medium may include any mechanism for storing information in a form readable by a machine (e.g., a computer). For example, a non-transitory computer-readable storage medium may include read-only memory (ROM), random-access memory (RAM), magnetic disk storage media, optical storage media, flash-memory devices, and other non-transitory media.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

FIG. 1C depicts components that can be employed in system configurations enabling the systems and technical effect of this disclosure, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

### IV. Access Via Browser

In at least some configurations, a user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

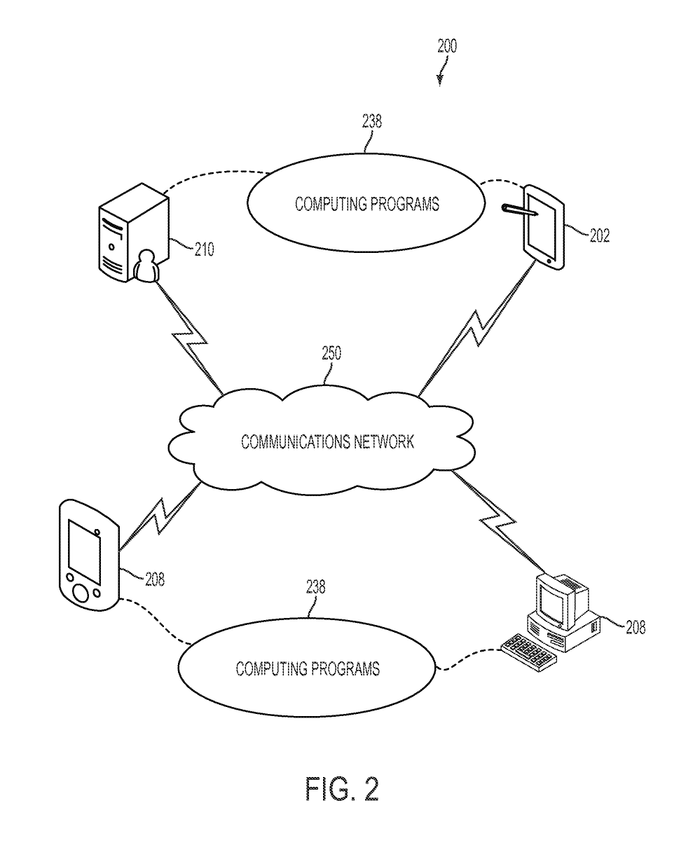

Computing system 100, described above, can be deployed as part of a computer network used to achieve the desired technical effect and transformation. In general, the above description for computing environments applies to both server computers and client computers deployed in a network environment. FIG. 2 illustrates an exemplary illustrative networked computing environment 200, with a server in communication with client computers via a communications network 250. As shown in FIG. 2, server 210 may be interconnected via a communications network 250 (which may be either of, or a combination of a fixed-wire or wireless LAN, WAN, intranet, extranet, peer-to-peer network, virtual private network, the Internet, or other communications network) with a number of client computing environments such as tablet personal computer 202, smart phone 204, personal computer 208, and personal digital assistant. In a network environment in which the communications network 250 is the Internet, for example, server 210 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 400 can utilize various data security protocols such as secured socket layer (SSL) or pretty good privacy (PGP). Each client computing environment can be equipped with operating system 238 operable to support one or more computing applications, such as a web browser (not shown), or other graphical user interface (not shown), or a mobile desktop environment (not shown) to gain access to server computing environment 200.

In operation, a user (not shown) may interact with a computing application running on a client computing environment to obtain desired data and/or computing applications. The data and/or computing applications may be stored on server computing environment 200 and communicated to cooperating users through client computing environments over exemplary communications network 250. The computing applications, described in more detail below, are used to achieve the desired technical effect and transformation set forth. A participating user may request access to specific data and applications housed in whole or in part on server computing environment 200. These data may be communicated between client computing environments and server computing environments for processing and storage. Server computing environment 200 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VII. Software Programs Implementable in the Computing and Network Environments to Achieve a Desired Technical Effect or Transformation

A. Use of the System

After accessing the system (e.g., by logging on via a web interface, or launching a desktop icon) a user, or a third party working with the user, selects one or more real world abilities or cognitive abilities for improvement. Based on these selections, an individualized training regimen that optimizes the selection of exercises for creating the desired improvements is developed or created. Users can subsequently train on this individualized, goal-based training regimen at their convenience, training on exercises in a prescribed order. In some configurations, the order of the exercises can be dynamically changed in response to a user's performance on one or more exercises already presented. Additionally, exercises can be presented in an order based on, for example, difficulty, time required, position of the exercise relative to the desired skill or skills on a matrix, etc.

B. Transfer of Cognitive Training Benefits

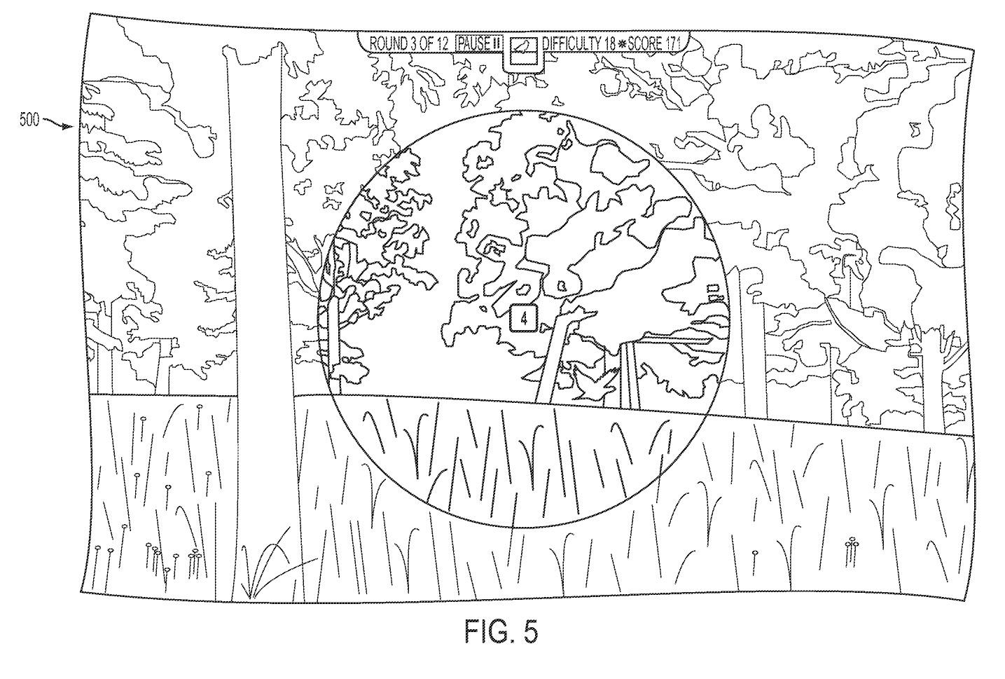

Transfer of cognitive training from doing one task—e.g., cognitive training exercises—to another—e.g., cognitive assessments or real world tasks—depends on change in the underlying neurocognitive mechanisms that make up the cognitive space. In other words, if a user engages with an exercise for an extended period of time, that user will improve on the exercise, partly because they have learned the task-specific elements of doing that exercise. In the case of effective cognitive training exercises (e.g., FIGS. 5-7), that user will also improve at other tasks that require shared underlying neurocognitive mechanisms for performance. The degree of transfer is captured in the model as a proportion of the distance between the training exercise and the outcome variable of interest (e.g., assessment or response to a real world outcome question).

C. Desired Outcomes of Cognitive Training

In an aspect, a user indicates his or her preferences, and then a selection of training exercises to be included in a user's training regimen is generated as a function of an identified desired cognitive outcome of the training. The cognitive training system then presents the user with questions regarding desired benefits of training. A few examples are below:

Which of the following real life abilities would you most like to improve:
(1) Driving (i.e., avoiding accidents)
(2) School performance
(3) SAT preparedness
(4) Reading comprehension

In another aspect, users can be asked, for example, to rate, “How much would you like to improve each of these abilities, on a scale of 1-5 with 1 being very much and 5 being not at all?” Finally, a third aspect is configurable to ask a user to, for example, rank the real life abilities in terms of their relative importance for the user.

These questions mirror the queries discussed above one-to-one, with each ability included in the cognitive space being reflected in the preference questions. As such, each preference can be mapped to a location in the principal component space of cognition, corresponding to the ability question. These user specific preferences are then stored in a database and used as parameters in calculation of a desired training program which is customizably configured to achieved the desired results.

Moreover, methods are configurable to take advantage of the fact that people who are good at a particular real world ability (e.g., driving without crashing) are strong on the underlying neurocognitive abilities that support performance on the related task. Performance on these real world abilities can be captured in the same cognitive space as performance on exercises. Thus, those wishing to improve on this real-world task can do so by enhancing these shared neurocognitive systems by playing exercises that are closely related in the cognitive space.

D. Calculating Training Regimen

The position of the cognitive abilities in the cognitive space is used in conjunction with the user's ability preferences to create a training regimen. Cognitive training exercises that are located closer to the desired ability in the cognitive space will more efficiently drive improvements on those abilities. Therefore, these tasks should be presented more frequently in training. The method described here uses this information to create a list of games specifying the order in which and how often the various exercises should be presented in training.

In a first implementation of a method according to the disclosure, each exercise is assigned a probability of being presented at a given training time based on its distances to the desired outcome(s). For the case where the user is asked to rate the most important skill, the probability calculation is performed as follows:

$${p}_{ai} = \frac{{d}_{ai}}{{\sum }_{j = 1}^{J} {d}_{aj}} \qquad EQUATION 1$$

where, for a set of J exercises, pᵢ is the probability that the ith (i=1, . . . , J) exercise will be selected as the activity for any given slot in the training regimen and dₐᵢ is the distance in the cognitive space between the exercise i and the to-be-trained ability a.

Additional rules may be used to modulate this exercise selection rule in the creation of an exercise regimen. For example, it may be desirable to not repeat a given exercise on a given day. Also, some exercises are known to be more difficult than others. It may be desirable to require that easier variants be introduced into training prior to more difficult variants. Thus, the use of space from the desired outcome in the cognitive space is the foundation of a training regimen algorithm, but can be used in conjunction with other rules and algorithms.

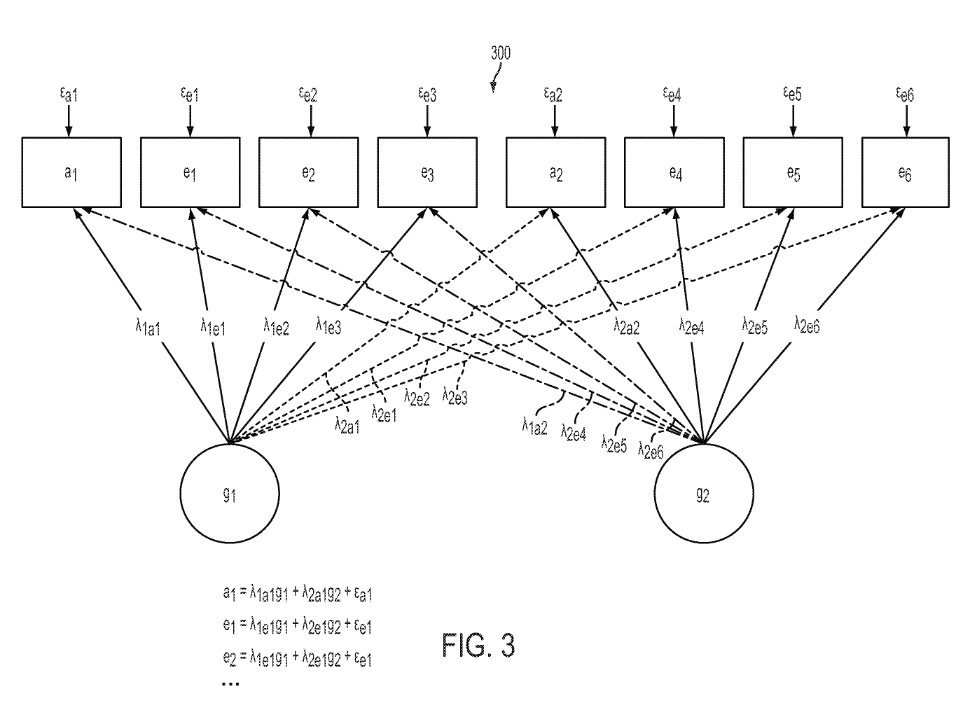

FIG. 3 illustrates the principal components 300 of the cognitive structure. The principal component can be comprised of a principal component value which is further comprised of, for example, real-world task component having a value, a cognitive exercise component having a value, and/or a cognitive ability dimension component having a value. The component values can be weighted based on a variety of variables and dimensions. This model places real-world task performance (a's) in the same structure as performance on cognitive exercises (e's). Cognitive ability dimensions (g's) underlie performance on each, thus training on games that load heavily on a cognitive ability will lead to improvements in real-world performance on tasks that also really on those abilities. The full model contains all exercises and real-world tasks used in the program and n cognitive ability dimensions. The resulting model provides a dimensionality to the tasks and cognitive ability dimensions to facilitate identification of the most relevant exercises based on spatial positioning of the desired tasks and cognitive abilities compared to the tasks and cognitive abilities being trained.

Thus, in the example of real world task performance ability a₁ a value can be estimated as:

a₁=λ₁ₐ₁g₁+κ₂ₐ₁g₂+εₐ₁ EQUATION 2

Where λ₁ₐ₁ is i the factor (or principal component) loading of ability a₁ on cognitive dimension 1 (g₁), κ₂ₐ₁ is the factor (or principal component) loading of ability a₂ on cognitive dimension 2 (g₂), and εₐ₁ is the error term associated with this ability.

The cognitive ability dimensions g₁ and g₂ can be related to real world task performance (a's) and cognitive exercises (e's) by a corresponding λ, as shown.

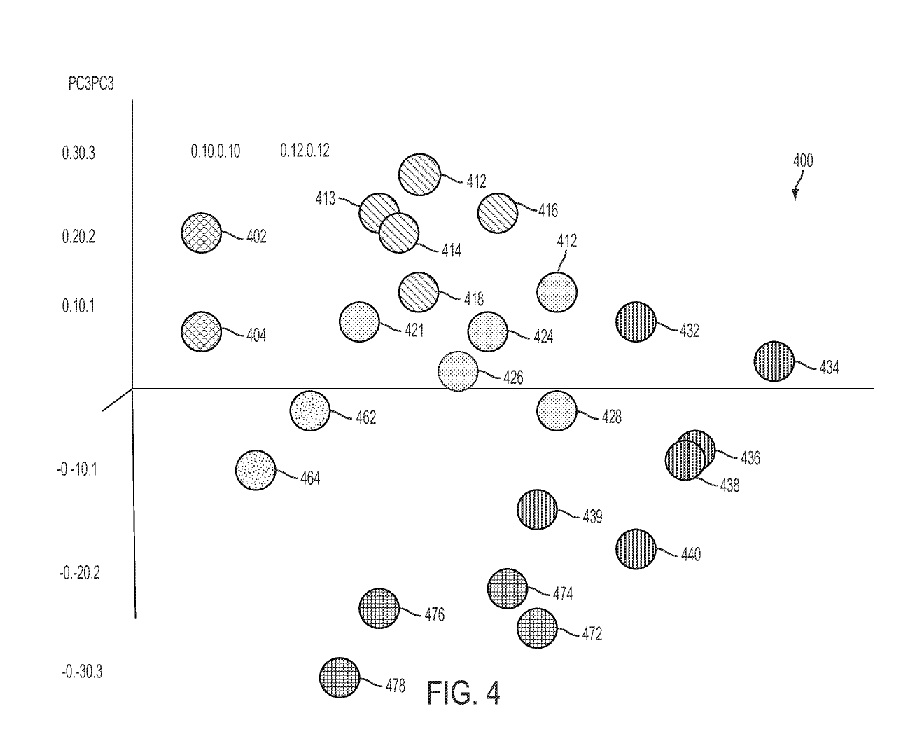

In use, a user, for example, identifies either a desired benefit and/or a current skill for improvement. Users can identify more than one benefit or skill if desired. The identified benefit and/or skill has a coordinate position which is comprised of other components, such as a real-world task component, a cognitive exercise component, and a cognitive ability dimension component. From the coordinate position, a cluster position can be determined (as discussed with respect to FIG. 4). Once one or more cluster positions is determined one or more training stimuli or exercises can be selected based on the location of the training stimuli's cluster position relative to the cluster position of the desired benefit or skill.

FIG. 4 is a chart 400 that shows a representation of a subset of the coordinate positions emerging from performance abilities (based on initial, pre-training, task performance) among a population of users across various cognitive training exercises and assessments in a database of cognitive performance. This representation contains the first 3 coordinate positions. The values on the x-y-z coordinate relate to the corresponding principal component loadings associated with performance on each task. Exercises that load heavily on (i.e., depend on or are limited by) the cognitive ability represented by g₁ will have large absolute values along the x-axis in this diagram. Exercises that load heavily on g₂ will have large absolute values along the y-axis, and so on up to n dimensions of cognitive space where n corresponds to the number of variables (i.e., task and real-world performance abilities) used to create the space. The closer two tasks are in this cognitive space, the more similar are the loadings on the various cognitive capacities that make up the space (i.e., performance on the tasks depends on similar abilities, and performance on them is thus correlated across individuals). In the current best mode, only dimensions that account for significant amounts of variance are included in the calculation of distance within the space, where any of several techniques well known to those skilled in the art are used to evaluate significance.

The format of the dots correspond to cluster membership, which need not be used in this method. For example entries 402 and 404 fall within the same cluster, while entries 412, 414, and 416 fall within another cluster. The points correspond to the location of performance on the various exercises and assessments on the system in the coordinate positions space. The distance between these tasks and real-world performance abilities determines which exercises will maximally benefit performance on those tasks. The distance is definable across users without necessarily taking into account individual differences in performance. As individual component can be based on selected preferences for a desired benefit.

A table of the exemplar entries from the matrix in FIG. 4 and a corresponding cognitive ability is summarized in Table 1.

TABLE 1

| Entry # | Name | Cognitive Skill |
|---|---|---|
| 402 | Name Tag | Face-name recall |
| 404 | By the Rules | Logical reasoning |
| 412 | Monster Garden | Working Memory |
| 413 | Visual Memory | Working Memory |
| 414 | Reverse Visual Memory | Working Memory |
| 416 | Moneycomb | Working Memory |
| 418 | Top Chimp | Visual Attention |
| 421 | Go no Go | Response Inhibition |
| 422 | Birdwatching | Visual Attention |
| 424 | Trail Making Part A | Visual Attention |
| 426 | Trail Making Part B | Cognitive Flexibility |
| 428 | Brain Shift | Cognitive Flexibility |
| 432 | Penguin Pursuit | Spatial Orientation |
| 434 | Lost in Migration | Response Inhibition |
| 436 | Spatial Speed Match | Speed of Processing |
| 438 | Color Match | Response Inhibition |
| 439 | Memory Match | Working Memory |
| 440 | Speed Match | Speed of Processing |
| 462 | Digit Span | Working Memory |
| 464 | Letter memory | Working Memory |
| 472 | Chalkboard challenge | Quantitative Reasoning |
| 474 | Raindrops | Quantitative Reasoning |
| 476 | Wordy Equations | Verbal Fluency |
| 478 | Word Bubbles | Verbal Fluency |

FIG. 5 illustrates a screenshot 500 showing a basic stimulus display for an exercise. As will be appreciated by those skilled in the art, an exercise can provide stimulus to a user that is visual, audible, or a combination thereof. In this task, a user must indicate where on the screen the bird appeared (it's only flashed for a brief period) and which number appeared in the center (illustrated as a number 4 within a box). This exercise targets visual divided attention. Similar exercises have been shown to be effective in reducing the motor vehicle accidents in participants who trained.

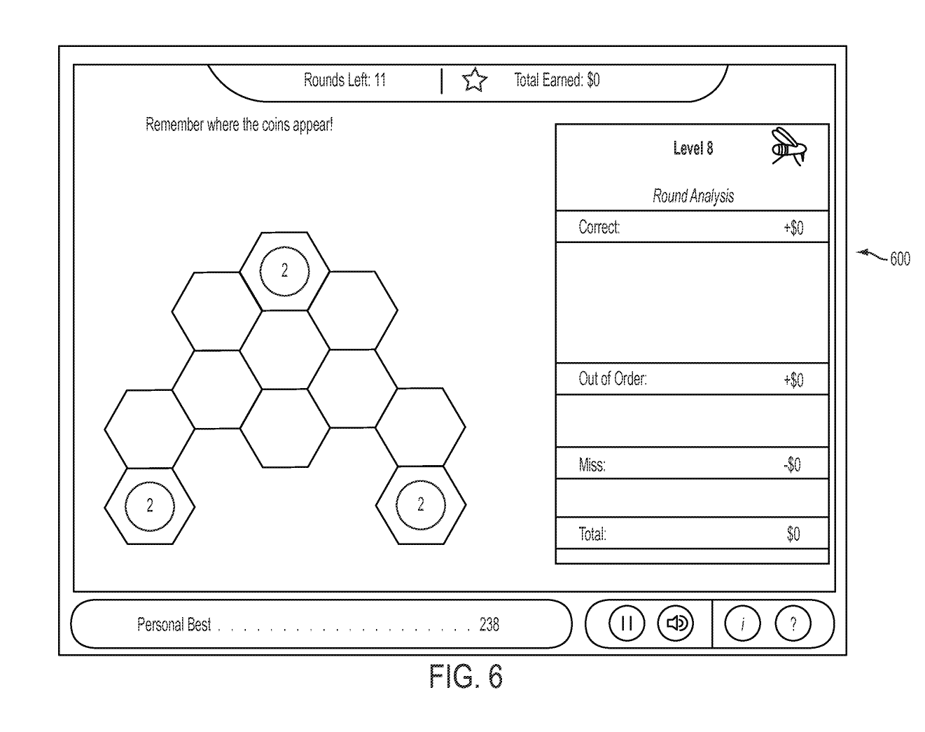

FIG. 6 is a screenshot 600 of an exercise where a user is required to remember the location of three (3) sets of coins. Users are required to remember the location of 3 sets of coins presented in varying arrangements on the grid. This exercise targets visual working memory and executive attention. When users are successful, more coins are added to the patterns.

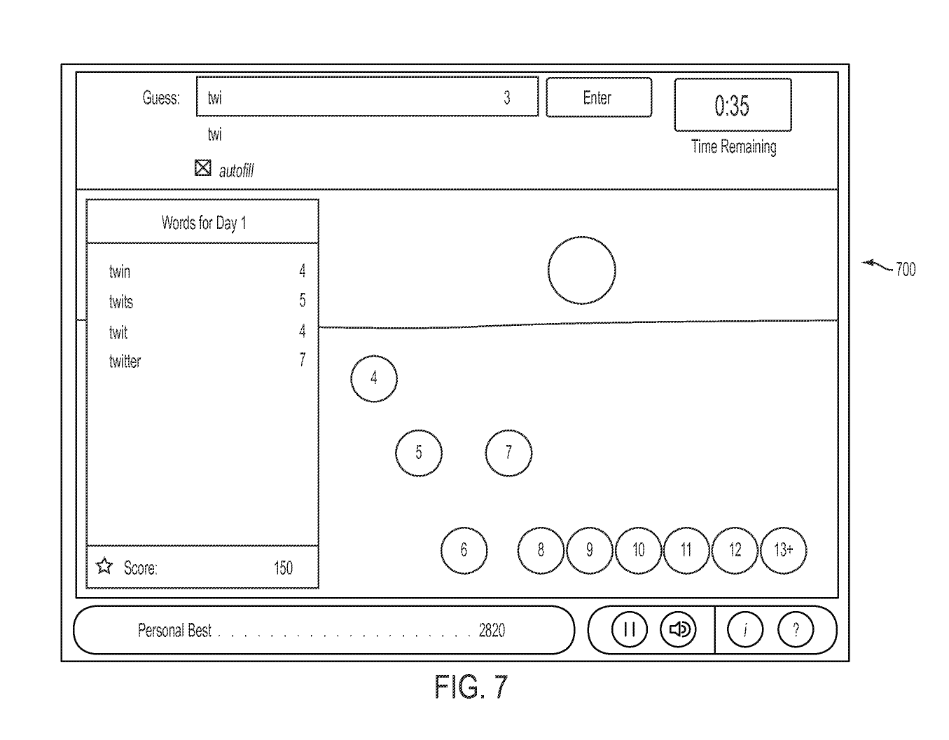

FIG. 7 is a screenshot 700 of an exercise where a user completes three letter word stems (in this example words that begin with TWI). In this exercise, users complete three letter word stems with as many words as possible within a set amount of time (as illustrated) or in a timed manner. This exercise targets verbal fluency

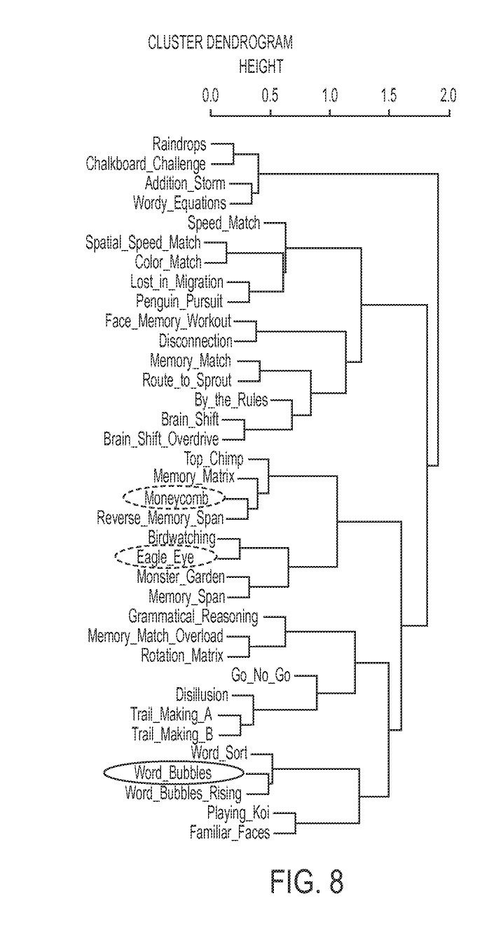

FIG. 8 is a cluster dendrogram 800, or tree illustrating an arrangement of the clusters in a hierarchical format, illustrating a relationship between exercises of the system. The dendrogram is a convenient way to visualize some of the relationships in the coordinate positions space, as measures that are closer in the principal component space will tend to group together in the dendrogram. It can be clearly seen that of the exercises presented in FIGS. 3-5 the two depending on the dynamic allocation of visual attention and working memory (Moneycomb and Eagle Eye) are more closely related than the exercise depending on verbal fluency ability (Word Bubbles). The method described in this specification will create a training regimen that weights the dynamic visual attention exercises more heavily than the verbal exercise when the user indicates that he or she wishes to improve performance on tasks that are closely related to these exercises in the principal component space—like driving without getting in an accident. The opposite would be true in cases where the user indicates that he or she wants to improve performance on tasks associated with verbal fluency in the space—e.g., improving performance on recalling names of people you've met.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A non-transitory computer readable medium storing instructions that, when executed by a computing device, causes the computing device to perform a method, comprising:
code for receiving from a user computing device at least one of an identifier for a desired benefit and an identifier for a current skill;
code for identifying, for the at least one of the identifier for the desired benefit and the identifier for the current skill, a coordinate position wherein the coordinate position is further comprised of two or more of a real-world task component, a cognitive exercise component, and a cognitive ability dimension component;
code for determining a cluster position from at least two or more of the identified real-world task component, cognitive exercise component, and cognitive ability dimension for the at least one of the identifier for the desired benefit and the identifier for the current skill;
code for calculating a probability, for one or more of the visual stimuli for training and audible stimuli for training, that the training will be presented to the user, as a function of the cluster position of the at least one of the identifier for the desired benefit and the identifier for the current skill; and
code for selecting one or more visual stimuli for training and audible stimuli for training for presentation to the user based on the calculated probability.

2. The non-transitory computer readable medium of claim 1 wherein the code for receiving receives the code for receiving via a web-server.

3. The non-transitory computer readable medium of claim 1 wherein the code for providing the at least one of the visual stimuli for training and the audible stimuli for training to the user computing device is provided via a web-server to the user computing device.

4. The non-transitory computer readable medium of claim 1 further comprising code for providing the user computing device the selected one of a visual stimuli for training and an audible stimuli for training for enhancing cognition in the user.

5. The non-transitory computer readable medium of claim 1 further comprising code for analyzing the participant response.

6. The non-transitory computer readable medium of claim 1 further comprising code for calculating probability according to the following equation
$${p}_{ai} = \frac{{d}_{ai}}{{\sum }_{j = 1}^{J} {d}_{aj}}$$
where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a.

7. The non-transitory computer readable medium of claim 1 further comprising code for assigning a difficulty rating of the one or more visual stimuli for training and audible stimuli for training.

8. A computing device comprising:
a processor configured to:
receive from a user computing device at least one of an identifier for a desired benefit and an identifier for a current skill;
identify, for the at least one of the identifier for the desired benefit and the identifier for the current skill, a coordinate position wherein the coordinate position is further comprised of two or more of a real-world task component, a cognitive exercise component, and a cognitive ability dimension component;
calculate a cluster position from at least two or more of the identified real-world task component, cognitive exercise component, and cognitive ability dimension for the at least one of the identifier for the desired benefit and the identifier for the current skill;
calculate a probability, for one or more visual stimuli for training and audible stimuli for training, that the training will be presented to the user as a function of the cluster position of the at least one of the identifier for the desired benefit and the identifier for the current skill; and
select one or more visual stimuli for training and audible stimuli for training for presentation to the user based on the calculated probability.

9. The computing device of claim 8 wherein the processor is further configured to transmit one or more visual stimuli for training and audible stimuli for training from a server, to the user computing device.

10. The computing device of claim 9 wherein the processor is configured to receive via a web-server.

11. The computing device of claim 9 wherein the processor is configured to provide the at least one of the visual stimuli for training and the audible stimuli for training to the user computing device is via a web-server to the user computing device.

12. The computing device of claim 9 wherein the processor is configured to provide the user computing device the selected one of a visual stimuli for training and an audible stimuli for training for enhancing cognition in the user.

13. The computing device of claim 9 wherein the processor is configured to require the participant to respond to the stimuli.

14. The computing device of claim 9 wherein the processor is configured to analyze the participant response.

15. The computing device of claim 9 wherein the processor is configured to calculate the probability according to the following equation
$${p}_{ai} = \frac{{d}_{ai}}{{\sum }_{j = 1}^{J} {d}_{aj}}$$
where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a.

16. The computing device of claim 9 wherein the processor is configured to assigning a difficulty rating of the one or more visual stimuli for training and audible stimuli for training.

17. The computing device of claim 16 wherein the processor is configured to order the one or more visual stimuli for training and audible stimuli for training, and presenting the one or more visual stimuli for training and audible stimuli for training in an order based on the difficulty rating.

18. A method comprising:
receiving from a user computing device at least one of an identifier for a desired benefit and an identifier for a current skill;
identifying, for the at least one of the identifier for the desired benefit and the identifier for the current skill, a coordinate position wherein the coordinate position is further comprised of two or more of a real-world task component, a cognitive exercise component, and a cognitive ability dimension component;
calculating a cluster position from at least two or more of the identified real-world task component, cognitive exercise component, and cognitive ability dimension for the at least one of the identifier for the desired benefit and the identifier for the current skill;
calculating a probability, for one or more of the visual stimuli for training and audible stimuli for training, that the training will be presented to the user, as a function of the cluster position of the at least one of the identifier for the desired benefit and the identifier for the current skill; and
selecting one or more visual stimuli for training and audible stimuli for training for presentation to the user based on the calculated probability.

19. The method of claim 18 wherein the receiving takes place via a web-server.

20. The method of claim 19 wherein providing the at least one of the visual stimuli for training and the audible stimuli for training to the user computing device is via a web-server to the user computing device.

21. The method of claim 19 further comprising the step of providing the user computing device the selected one of a visual stimuli for training and an audible stimuli for training for enhancing cognition in the user.

22. The method of claim 19 further comprising the step of requiring the participant to respond to the stimuli.

23. The method of claim 19 further comprising the step of analyzing the participant response.

24. The method of claim 19 wherein the probability is calculated according to the following equation
$${p}_{ai} = \frac{{d}_{ai}}{{\sum }_{j = 1}^{J} {d}_{aj}}$$
where, J is a subset of exercises, pᵢ is the probability that the ith (i=1, . . . , J) exercise will be selected as the activity for any given slot in the training regimen and dₐᵢ is the distance in the cognitive space between the exercise i and the to-be-trained ability a.

25. The method of claim 19 further comprising the step of assigning a difficulty rating of the one or more visual stimuli for training and audible stimuli for training.

26. The method of claim 25 further comprising the step of ordering the one or more visual stimuli for training and audible stimuli for training, and presenting the one or more visual stimuli for training and audible stimuli for training in an order based on the difficulty rating.
